(19) United States
(12) Patent Application Publication
(10) Pub. No.: US 2004/0073668 A1
(43) Pub. Date: Apr. 15, 2004

(54) Policy delegation for access control

(76) Inventors: Shivaram Bhat, Sunnyvale, CA (US); Hua Cui, Fremont, CA (US); Ping Luo, Union City, CA (US); Dilli Dorai Minnal Arumugam, Cupertino, CA (US); Aravindan Ranganathan, San Jose, CA (US)

Correspondence Address: WAGNER, MURABITO & HAO LLP, Third Floor, Two North Market Street, San Jose, CA, 95113, US

(21) Appl. No.: 10/269,957

(22) Filed: Oct. 10, 2002

(51) Int. Cl. G06F 15/173

(52) U.S. Cl. 709/225

(57) ABSTRACT

A method and system thereof for controlling access to resources. Access to a resource is controlled by a policy definition. A request for access to a resource is received at a first agent. The first agent is authorized to refer policy definitions to other agents. The policy definition for the resource is delegated to a second agent by the first agent using a referral policy. The referral policy includes identification of the resource and identification of the second agent. The second agent is the source of the policy definition that governs access to the resource. The request for access is forwarded to the second agent according to the referral policy. Based on the policy definition, a decision can be made regarding whether the request for access to the resource is granted. The decision can also indicate the actions that may be performed using the resource.

### BACKGROUND OF THE INVENTION

1. Field of the Invention

The field of the invention relates to computer-implemented policies for controlling access to private resources. More specifically, embodiments of the present invention relate to the delegation of policy making, policy evaluations, and policy decisions.

2. RELATED ART

Changes in technology have profoundly affected how people use computers. For example, the widespread proliferation of computers has prompted the development of computer system networks that allow computers to communicate with each other. Accordingly, a large number of people—within a company, for example—can communicate at the same time with a central software application running on one computer system. However, with the sharing of software applications among users, policies must be defined and enforced that control the access and use of particular software applications, to prevent unauthorized access and use.

Referring now to Prior Art FIG. 1, a block diagram of a portion of a general network system 10 is shown. The system 10 includes a client node 20 coupled to a server 21. Typically, client node 20 will access an application 22 that is stored on server 21 over the Internet. In a corporate environment, the client node 20 could be connected to the server 21 by an internal network (e.g., an Intranet). In addition, server 21 stores a set of user policies in a database 23 for authenticating access to software application 22. Typically, the user policy database 23 includes user names and associated passwords. When a user provides credentials to access secure applications, the credentials are checked against the stored values.

Users on an Intranet have access to applications that would not typically be accessible to users that are not connected to the corporate network. By limiting the use of applications to users connected to the network, a degree of security can be provided because only users inside the corporation can access the applications. Although somewhat secure, users may find this approach inconvenient, because some users may need to access applications on a corporate server when they are not at the office (and thus not connected via an Intranet).

To overcome this problem, some networks are configured to allow remote access to a server over the Internet. To achieve secure remote access to a server, corporations create a “portal” for users to log into the server while not connected to the Intranet. Typically, a user will provide credentials such as a user name and password to gain access to the corporate server over the Internet. Once a user has provided authentic credentials, the server system checks a database to verify that the user should have access to a particular application.

Often, it is important for access control policies to be customized for different users and for different applications, because many times all users do not need access to all applications stored on the server. For example, access control policies defined for a human resources server are intended to prevent unauthorized personnel from viewing confidential salary information and other sensitive data. Access control policies for an engineering server allow authorized personnel to share research and development information while, at the same time, restricting external partners from gaining access to proprietary information.

It is beneficial to create specific access control policies for all users and applications because it provides a customizable and more secure computing environment. However, these policies can become more complex as decisions need to be made and enforced as to whom is allowed access to what and under what conditions, and what permissions are granted once access is achieved. In larger companies with more users, more applications, and more access controls policies, the issue of complexity is exacerbated. The task of creating new access control policies, in addition to the tasks of updating and maintaining greater numbers of existing access policies of increasing complexity, can be very burdensome to administrators of such policies.

### SUMMARY OF THE INVENTION

Accordingly, a method and/or system that can lessen the burden on those who administer access control policies would be beneficial. Embodiments of the present invention provide a solution to such a problem.

Embodiments of the present invention provide methods and systems that permit the task of creating (defining) policies to be delegated among a number of administrators while facilitating the implementation of policy definitions in software. According to the embodiments of the present invention, policy delegation is achieved through referral policies, which control policy delegation for both policy creation and policy evaluation (implementation).

In one embodiment, a request for access to a resource is received at a first agent. The first agent is authorized to refer policy definitions to other agents. The policy definition for the resource is delegated to a second agent by the first agent using a referral policy. The referral policy includes identification of the resource and identification of the second agent. The second agent is the source of the policy definition that governs access to the resource. The policy definition also may govern what actions on the resource are permitted once access is granted. The request for access is forwarded to the second agent according to the referral policy. Based on the policy definition, a decision can be made regarding whether or not the request for access to the resource is granted. Decision values for controlling actions that may be performed on the resource may also be returned along with the decision on whether access is granted or not.

Because policy definitions can be delegated, the creation of those policies can also be delegated among organizations and among the administrators for those organizations, thus distributing the workload associated with defining, implementing, updating and maintaining such policies. These and other objects and advantages of the present invention will no doubt become obvious to those of ordinary skill in the art after having read the following detailed description of the preferred embodiments, which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention.

Prior Art FIG. 1 is a block diagram of a prior art server system including an application that is available to a user over a network connection.

FIG. 2 is a block diagram of an exemplary computer system upon which embodiments of the present invention may be implemented.

FIG. 3 illustrates an access control policy architecture in accordance with one embodiment of the present invention.

FIG. 4 is a block diagram of another embodiment of an access control policy architecture in accordance with the present invention.

FIG. 5 is a flowchart of a method for controlling access to a resource in accordance with one embodiment of the present invention.

### DETAILED DESCRIPTION OF THE INVENTION

Reference will now be made in detail to the various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the present invention.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, bytes, values, elements, symbols, characters, terms, numbers, or the like.

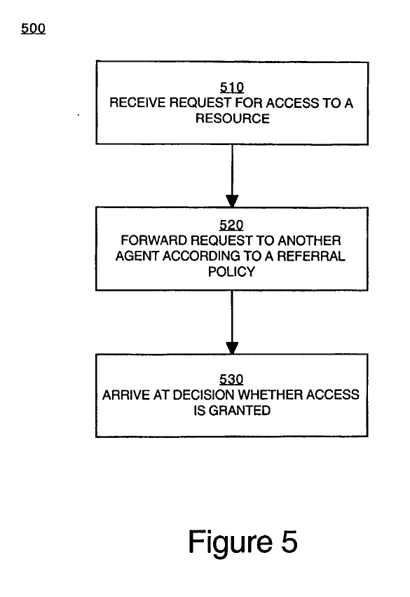

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving,” “forwarding,” “returning,” “retrieving,” “caching,” “evaluating,” “entering,” or the like, refer to the action and processes (e.g., flowchart 500 of FIG. 5) of a computer system or similar intelligent electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention allow the tasks of defining and implementing (evaluating) access control “policies” to be delegated using a policy “referral.” Access control policies may contain “rules,” “subjects” and “conditions” that are evaluated to determine whether access to a “resource” will be granted to a requester (e.g., a “subject”), and what actions can be performed on or using the resource should access be granted. Referral policies may contain rules, subjects, conditions and referrals. The term “policy definition” is used herein to refer to an access control policy or referral policy that has been defined and which can be implemented in software.

The following is a format that may be used to define a policy, although embodiments of the present invention are not so limited:

[[Rule][Subject][Referral][Condition]].

There may be one or more rules, subjects, referrals and conditions in the policy. Moreover, a policy may be defined without a subject, referral, and/or condition.

A resource (e.g., a service or application) may have more than one policy associated with it. Examples in which there may be multiple policies for a resource would typically exist in an Internet Service Provider (ISP) or Application Service Provider (ASP) environment that hosts multiple organizations, each organization having its own specific policy. As will be seen, these organization-specific policies can be implemented using policy referrals in accordance with the embodiments of the present invention.

As mentioned, policies may be based solely on subject(s). A subject may define an individual user or a collection (group) of users to whom the policy applies. Access to and use of a resource may be granted to a user recognized as having a certain role (e.g., manager) or as being a member of a certain group (e.g., marketing).

Usually, persons or entities identify themselves during the authentication process. Once they have been authenticated, they are provided with one or more identities referred to using the term “principal.” The term “principal” may refer to an identity of the user (or an entity) as represented (or understood) by an application, or a server, or a device.

Hence, a subject may represent a collection of identities, wherein each identity is represented as a principal. For example, Jane Doe is a subject. Jane Doe may have a first e-mail account under the principal name ‘jdoe,’ a second e-mail account under the principal name ‘janedoe,’ and an e-commerce buyer service account under the principal name ‘jane_doe’. Thus, the same subject, Jane Doe, has three principal names (or identities) based on which service she accesses. Principals usually become associated with a subject upon successful authentication to a resource (e.g., an application or a service). Because a subject may represent a nameless container holding relevant information for a user, while principals may represent named identities for that subject, the set of permissions granted to a subject depends on the principals associated with that subject and not on the subject itself.

A rule is a combination of “service type,” “resource,” “action” and “action value.” The following is a format that may be used to define a rule, although embodiments of the present invention are not so limited:

[<Service Type>, <Resource>, [<Action>, <Action Value(s)>]].

There may be one or more action values, and either one resource name or no resource names. A service type is a general term used to identify the type of application, service or device. Service types may be selected from a set of predefined terms. Example service types are Web service, mail service, etc.

A resource is an object defined by the service type and identifiable by a unique name. A resource may be an application or a service, for example. The resource name may be an object name (e.g., MailServer1), a Uniform Resource Identifier, or some other type of unique identifier.

An action refers to an operation or an event that can be performed on a resource. An action value refers to the value(s) an action can have. These terms are further explained by way of example, as follows.

A resource may be a Web site such as http://sunweb.sun.com. According to this example, an action may be a get, put, delete, or post operation according to the Hypertext Transfer Protocol (HTTP). For each of these actions, there may be an action value, such as allow/deny or yes/no. Thus, the action value may define whether the action is permitted.

The preceding example illustrates binary actions. Non-binary actions are possible as well. For example, a catalog service could have the following actions: allowed_Discount, purchase_Options, etc. For the catalog service, the allowed_Discount action may have a number as its action value. The purchase_Options action may have certain pre-defined strings as its action values. Hence, action values may be arbitrary in format (e.g., Boolean, numeric, string, single value or multi-valued).

A condition may represent the constraints on a rule or a policy. For example, a constraint may be that an action of updating a catalog may only take place from 8:00 AM-8:00 PM. Another constraint may grant this action only if the request originates from a given set of IP (Internet Protocol) addresses or from the company Intranet.

When a resource is subject to an access control policy, a request for access to the resource is evaluated by a “policy evaluator.” The policy evaluator may be also referred to as a policy decision point or as a policy engine. The policy evaluator returns a “policy decision.” A policy decision refers to the value(s) returned by the policy evaluator. For example, in the case of Boolean actions, values for the policy decision may be true/false (or allow/deny or yes/no). The policy decision can be used to grant access to a resource, and to define the actions that may be performed on or using the resource after access is gained.

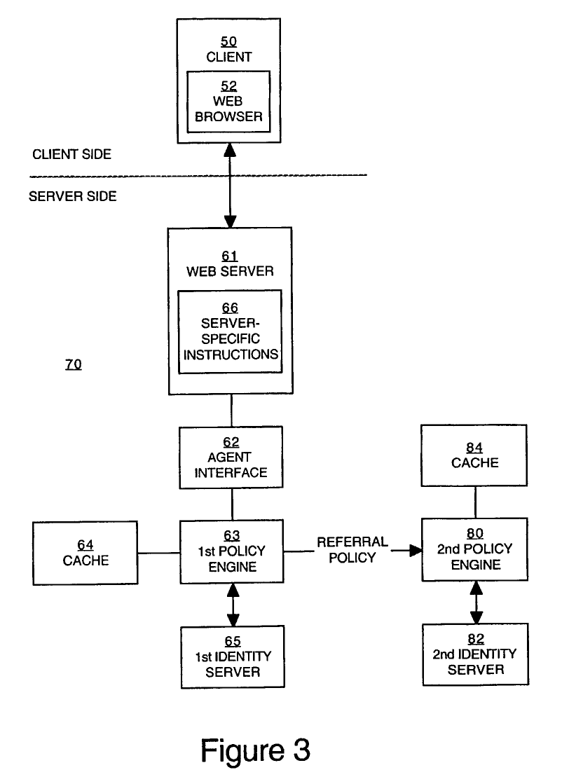

A policy referral involves the concept of forwarding a request for a particular resource from one policy decision point to another for evaluation. For example, in an ISP/ASP environment (and possibly within an enterprise), it may be necessary to delegate the policy definitions, evaluations and decisions for a resource to other organizations or sub-organizations. Taking the example of a Web service, an ISP may refer the policy decision for the resource http://www.acme.com to the ACME organization, and similarly the resource http://www.sun.com to the Sun organization. Additionally, it is possible to delegate the policy definitions, evaluations and decisions for a resource to other products that implement policies (e.g., the delegation may take place across products from different vendors). The referral concept is described in further detail in conjunction with FIGS. 3, 4 and 5, below.

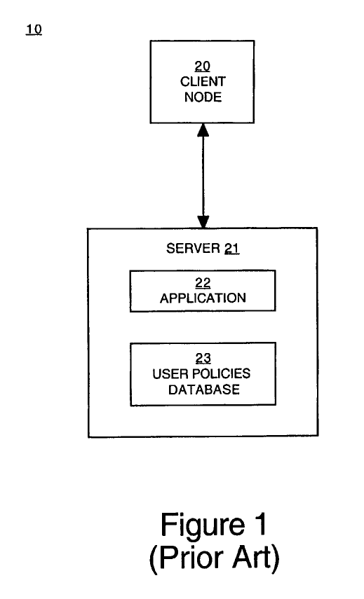

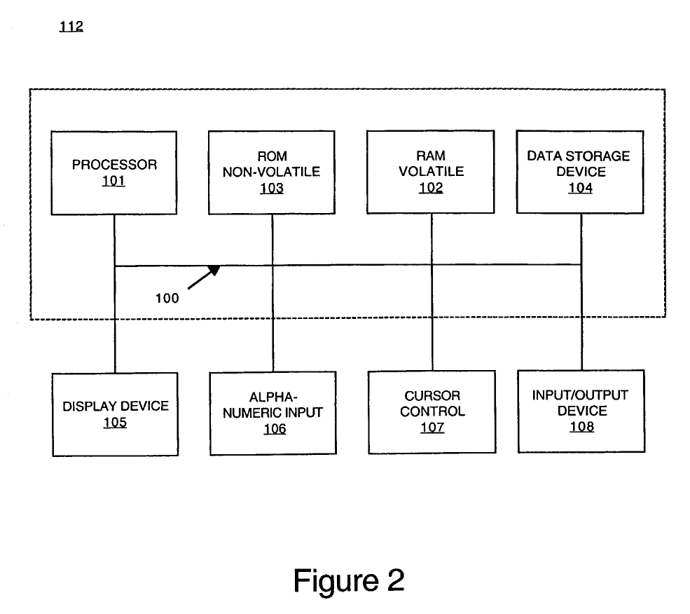

Referring first to FIG. 2, a block diagram of an exemplary computer system 112 is shown. It is appreciated that computer system 112 described herein illustrates an exemplary configuration of an operational platform upon which embodiments of the present invention can be implemented. Nevertheless, other computer systems with differing configurations can also be used in place of computer system 112 within the scope of the present invention.

Computer system 112 includes an address/data bus 100 for communicating information, a central processor 101 coupled with bus 100 for processing information and instructions; a volatile memory unit 102 (e.g., random access memory [RAM], static RAM, dynamic RAM, etc.) coupled with bus 100 for storing information and instructions for central processor 101; and a non-volatile memory unit 103 (e.g., read only memory [ROM], programmable ROM, flash memory, EPROM, EEPROM, etc.) coupled with bus 100 for storing static information and instructions for processor 101. Computer system 112 may also contain an optional display device 105 coupled to bus 100 for displaying information to the computer user. Moreover, computer system 112 also includes a data storage device 104 (e.g., disk drive) for storing information and instructions.

Also included in computer system 112 is an optional alphanumeric input device 106. Device 106 can communicate information and command selections to central processor 101. Computer system 112 also includes an optional cursor control or directing device 107 coupled to bus 100 for communicating user input information and command selections to central processor 101. Computer system 112 also includes signal communication interface (input/output device) 108, which is also coupled to bus 100, and can be a serial port. Communication interface 108 may also include wireless communication mechanisms.

FIG. 3 illustrates an access control policy architecture 70 in accordance with one embodiment of the present invention. The embodiment illustrated by FIG. 3 includes a number of functional blocks illustrated as separate elements. It is appreciated that the functionality provided by any of these elements may be combined and/or integrated with the functionality of one or more of the other elements. It is also appreciated that these elements may be implemented on a single computer system, or distributed among a number of different computer systems. For example, in one embodiment, the Web server 61 may be implemented using a first computer system; the agent interface 62, the first policy engine 63, and the cache 64 may be implemented on a second computer system; the first identity server 65 on a third computer system; the second policy engine 80 and the cache 84 on a fourth computer system; and the second identity server 82 on a fifth computer system. It is further appreciated that the architecture 70 may include additional elements not shown or described herein, and that the elements shown by FIG. 3 may implement additional functions not described herein. For example, the identity servers may each be coupled to a directory server that provides a database of user information, or the identity server may incorporate the functionality of a directory server. In addition, it is appreciated that the terms “first” and “second” are not relative terms but are used herein to differentiate between similarly named elements.

In the present embodiment, the architecture 70 includes a Web server 61, such as a Sun™ One Web, Apache, or Microsoft IIS (Internet Information Services) server, although the Web server 61 could be any server running on any platform. The server-specific instructions module 66 is a part of the architecture 70 that is specific to the Web server 61. The server-specific instructions module 66 intercepts an HTTP request for access to a resource on the Web server 61 and passes the request to the agent interface 62. The server-specific instructions are generally minimal even though different Web servers use different interfaces for implementing HTTP. For example, Sun™ One Web servers use NSAPI (Netscape Server Application Programming Interface) and IIS Web servers use ISAPI (Internet Server Application Programming Interface). However, both NSAPI and ISAPI comply with the same HTTP specifications. Accordingly, the basic mechanism for intercepting an HTTP event and enforcing policy for the resource is the same for both NSAPI and ISAPI.

The first and second policy engines 63 and 80 may also be referred to as policy decision points or policy evaluators. In general, in the present embodiment, the functions of the first policy engine 63 and of the second policy engine 80 include: defining policies for resources; evaluating the policies using the policy definitions; and returning the policy values (policy decisions) to the agent interface 62. The first and second policy engines 63 and 80 may also provide data coherency functions; that is, they may detect changes to the policy definitions, and update the caches 64 and 84 accordingly. In addition, the first and second policy engines 63 and 80 may be used to delegate the functions of defining and evaluating policies to one or more other policy engines (not shown), as will be described.

In one embodiment, the policy definitions for first policy engine 63 are stored on first identity server 65, and the policy definitions for second policy engine 80 are stored on second identity server 82. However, first policy engine 63 may utilize a cache memory 64 for storing policy definitions; once a policy definition is loaded in the cache memory 64, the first policy engine 63 does not need to fetch that information from first identity server 65, thus reducing the time it takes to retrieve policy definitions. In a similar manner, second policy engine 80 may store policy definitions in a cache memory 84.

First and second identity servers 65 and 82 may also include directory information or other information used in the definition and evaluation of policies. For example, these servers may have databases that include user (subject) information, such as names, addresses, and the like. These servers may also include attributes that identify which group or groups each subject belongs to (e.g., an attribute for “manager,” another attribute for “marketing,” etc.). Furthermore, these servers may include attributes associating each subject with their principal(s). As mentioned above, the first and second identity servers 65 and 82 may instead retrieve this information from one or more directory servers.

In the present embodiment, when a request is made for access to a resource, the agent interface 62 of FIG. 3 intercepts the request and communicates with the first policy engine 63 to determine if the resource is subject to a policy (e.g., an access control policy). If the resource is not subject to a policy, the request is directed to the resource (that is, access to the resource is granted). Conversely, if the resource is subject to a policy, the agent interface 62 refers the request to first policy engine 63, so that a determination can be made regarding whether or not access to the resource should be granted.

According to the present embodiment of the present invention, either first policy engine 63 or second policy engine 80 will perform the policy evaluation and return policy values (policy decisions) to the agent interface 62 for enforcement. Which of these policy engines performs the policy evaluation depends on whether or not a referral policy for the resource of interest is in place in first policy engine 63. In essence, if a referral policy applicable to the resource of interest is in place, the policy evaluation is performed by second policy engine 80; otherwise, the policy evaluation is performed by the first policy engine 63.

In the present embodiment, a policy referral includes identification of the resource to which access is being requested, and identification of the policy decision point (or organization) to which the evaluation is being delegated (referred). In one embodiment, using the rule format described earlier herein, an exemplary policy referral is given by:

[Web service (www.acme.com):/[All Actions]] [PolicyReferral Organization=“Acme”]

In the above example, policy definitions for the resource www.acme.com are referred to the Acme organization. Also, in one embodiment, policy evaluations for that resource are referred to the same organization. Note that referrals can be based on resources that are identified by something other than a Uniform Resource Identifier (URI) or Uniform Resource Locator (URL). For example, for a mail service, the resource may be based on the mail server name. Accordingly, a policy definition for “MailServer1” may be referred to “MailServer2” by name rather than by URI.

Referring still to FIG. 3, according to the present embodiment, a policy referral at first policy engine 63 might be of the form:

[Service Type (Resource) [Actions]] [PolicyReferral Organization=“Second Policy Engine 80”],

where “service type” and “actions” are described above, and “resource” identifies the resource for which policy definitions and evaluations are being delegated (referred). Note that although in the example of FIG. 3 there are only two policy engines, there may be in actuality more than two policy engines. Thus, for example, first policy engine 63 may refer (delegate) one policy definition and evaluation to one policy engine (e.g., second policy engine 80), and another policy definition and evaluation to another policy engine. These policy engines may in turn refer policy definitions and evaluations to other policy engines, including first policy engine 63.

Policy referrals may be made to peer organizations, to sub-organizations, or to higher-up organizations. That is, in a hierarchy of organizational entities, policy referrals may be made to organizations that are at the same level in the hierarchy, to organizations that are at lower (subordinate) levels in the hierarchy, or to organizations that are at higher levels in the hierarchy. In general, policy referrals are made from an organization that has responsibility for the policy definition for a resource and that has the authority to delegate that responsibility. In general, policy referrals are made to another organization or policy decision point, such as the organization or policy decision point that manages the resource itself (as opposed to controlling access to that resource).

In addition to the delegation of policy definitions and policy evaluations in software, the authority to create policies can also be delegated according to the various embodiments of the present invention. That is, an organization can be provided with the authority to not only maintain and evaluate policy definitions, but can be given authority to create new policies and modify existing policies. By way of example, consider an organizational structure in which isp.com has the authority to create (define) policies for resources at acme.com. Such an organizational structure may be hierarchically represented as:

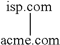

In order to also create policies for a resource at acme.com, according to one embodiment of the present invention, there needs to be a referral policy at isp.com. The referral policy at isp.com, in one embodiment, needs to identify the resource to be managed at acme.com, and needs to also identify acme.com as the organization the policy definition is being delegated to. For example, if the resource is “http://www.acme.com,” a referral policy in a rule format needs to include that resource identity and also needs to include a reference to acme.com (refer also to the previous example, above). With this type of policy referral at isp.com, policies can be created at acme.com for any resource having the prefix “http://www.acme.com.” For resources at acme.com that do not have this prefix, other referral policies need to be put in place at isp.com. Although this example is described in the context of organizations, policy referrals may be used in other contexts. Although described in the context of resources, policy referrals may also be used for rules, actions, subjects and/or conditions.

The embodiments of the present invention provide a great deal of flexibility with regard to the referral policies for delegating policy definitions and policy evaluations. A referral policy can be used by one entity to point to virtually any other entity such as organizations or other policy implementation products; in general, a referral policy can point to any other policy decision point.

Returning to FIG. 3, in one embodiment, once the policy definition is accessed and the policy evaluation completed (either by first policy engine 63 if there is no referral policy for the resource of interest, or by second policy engine 80 if there is a referral policy for that resource), the agent interface 62 uses the resultant policy values to enforce the policy. Alternatively, a different agent interface may be used, in particular if the policy definition and evaluation is handled by second policy engine 80. For instance, in one embodiment, the responsibility for the policy definition and evaluation may be delegated to second policy engine, which returns the policy values to agent interface 62. However, in another embodiment, the access request itself may be forwarded to an agent interface (not shown) that is associated with second policy engine 80, in which case a policy decision from second policy engine 80 is returned to this other agent interface.

In the present embodiment, the agent interface (e.g., agent interface 62) enforces the decision with regard to whether or not access to the resource of interest is granted. In one embodiment of the present invention, an agent interface (e.g., agent interface 62) enforces decision values that are more complex than binary decisions. For example, the agent interface 62 can enforce policies such as a memory quota for an electronic mail program. As another example, a user may access an electronic mail program on a server and attempt to use more than the allotted memory quota. The agent interface 62 would intercept the request for more memory and limit the use of memory to the amount defined in the policy definition for that resource.

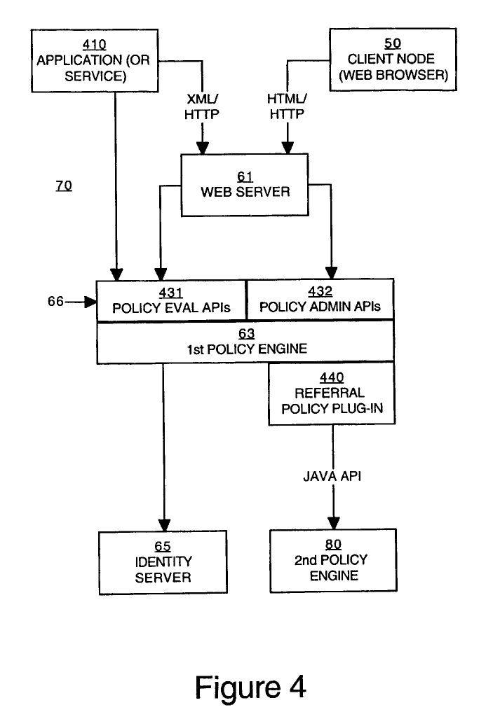

FIG. 4 is a block diagram of one embodiment of an access control policy architecture 70 in accordance with the present invention. The embodiment of FIG. 4 illustrates one type of implementation actualizing the embodiment of FIG. 3.

Referring to FIG. 4, in the present embodiment, first policy engine 63 incorporates policy evaluation application programming interfaces (APIS) 431 and policy administration APIs 432. The policy evaluation APIs 431 can be used for policy evaluation, and the policy administration APIs 432 can be used by administrators to manage (e.g., set, modify, delete) policy definitions (e.g., rules, etc.).

In one embodiment, a referral policy plug-in 440 provides an interface to the second policy engine 80. In one such embodiment, referrals to the second policy engine 80 are implemented using Java interfaces, specifically public Java interfaces.

As an example of a Java interface, the interface “com.sun.identity.policy.interfaces.referral” is defined as the following

/** interface to facilitate delegating policy evaluation
* There would be many implementations with different policy
* delegation mechanisms such as delegating to peer organizations
* only or delegating to sub organizations only.
*/
public interface Referral {
/**Gets policy results

* @param token SSOToken
* @param resourceType type of resource
* @param resourceName name of the resource
* @param actionNames a set of action names
* @param envParameters a map of environment parameters

* Each key is an environment parameter name.
* Each value is a set of values for the parameter.

* @return policy decision
*
* @throws PolicyException if an error occurred
* @throws SSOException if single sign on token is not valid
*/

PolicyDecision getPolicyDecision(SSOToken token, String
resourceType, String resourceName, Set actionNames, Map
envParameters)
throws SSOException, PolicyException;

}

In the above example, “environment” refers to the conditions that are provided with an access request. A single sign on token (SSOToken) is used for authentication purposes; generally, if such a token is present, then the user has been already authenticated. It is appreciated that other authentication schemes may be used in accordance with the present invention.

In the present embodiment, the first policy engine 63 is also coupled to an identity server 65, which may incorporate the features and functionality of a directory server. In one embodiment, the policy evaluation APIs 431 can interact with applications (or services) 410 that invoke these APIs directly, and the policy administration APIs 432 are targeted for administrators that manage the access control policies via either a browser (on client node 50, for example) or directly via command line interfaces (not shown). In one embodiment, in order to support the use of languages other than Java and C, for example, Web server 61 executes a servlet (not shown) that supports an Extensible Markup Language (XML)/HTTP interface. Accordingly, applications (or services) 410 can construct policy queries using XML and receive policy definitions or evaluate policies by using the servlet on Web server 61. This latter approach can also be used to overcome firewall issues that might prevent messages from applications that use Lightweight Directory Access Protocol (LDAP) from reaching the identity server 65.

FIG. 5 is a flowchart 500 of a method for controlling access to a resource in accordance with one embodiment of the present invention. Although specific steps are disclosed in flowchart 500, such steps are exemplary. That is, embodiments of the present invention are well suited to performing various other steps or variations of the steps recited in flowchart 500. It is appreciated that the steps in flowchart 500 may be performed in an order different than presented, and that not all of the steps in flowchart 500 may be performed. In one embodiment, the method of flowchart 500 is implemented by a computer system such as computer system 112 of FIG. 2.

In step 510 of FIG. 5, a request is received for access to a resource. In one embodiment, the request is received by an agent interface 62 of FIG. 3. Generally speaking, the request is received by a policy decision point or a policy evaluator such as first policy engine 63 of FIG. 3 (e.g., a “first agent”).

In step 520 of FIG. 5, the request of step 510 is forwarded to another policy decision point or policy evaluator such as second policy engine 80 of FIG. 3 (e.g., a “second agent”). The forwarding is performed according to a referral policy implemented by the first agent (e.g., first policy engine 63). In one embodiment, the referral policy identifies the resource of interest and the identity of the second agent (e.g., second policy engine 80).

In step 530 of FIG. 5, a decision is returned from the second agent with regard to whether or not access to the resource is granted. The decision from the second agent may also include decision values for enforcing the access control policy. For example, the decision values may indicate what actions may be performed on the resource once access is gained.

In summary, the embodiments of the present invention provide methods and systems that permit the task of defining policies to be delegated among a number of administrators while facilitating the implementation (evaluation) of the policy definitions in software, thus distributing the workload associated with defining, implementing, updating and maintaining such policies.

Embodiments of the present invention, policy delegation for access control, have been described. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and it's practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of controlling access to resources, said method comprising:
receiving at a first agent a request for access to a resource, wherein said first agent is authorized to delegate policy definitions that govern said resources to other agents; and
forwarding said request for access to a second agent that is a source of a policy definition that governs said resource, said forwarding performed according to a referral policy comprising identification of said resource and identification of said second agent, wherein said policy definition for said resource is delegated by said first agent to said second agent by said referral policy and wherein said second agent provides a decision regarding said request.

2. The method of claim 1 wherein said request for access is evaluated by said second agent.

3. The method of claim 1 wherein said second agent retrieves said policy definition from a source of policy definitions coupled to said second agent.

4. The method of claim 3 wherein said second agent caches said policy definition in a memory cache accessible by said second agent.

5. The method of claim 1 wherein said decision comprises a decision value indicating whether access to said resource is granted.

6. The method of claim 5 wherein said decision further comprises decision values indicating actions that may be performed with said resource.

7. The method of claim 1 wherein said referral policy uses a Java interface.

8. The method of claim 1 wherein said first agent is associated with a first organizational entity and said second agent is associated with a second organizational entity, wherein said second organizational entity is subordinate to said first organizational entity in an organizational hierarchy.

9. The method of claim 1 wherein said first agent is associated with a first organizational entity and said second agent is associated with a second organizational entity, wherein said first and second organizational entities are peers in an organizational hierarchy.

10. A computer system comprising:
a memory unit; and
a processor coupled to said memory unit, said processor for executing a method of controlling access to resources, said method comprising:
receiving at a first agent a request for access to a resource, wherein said first agent is authorized to delegate policy definitions that govern said resources to other agents; and
forwarding said request for access to a second agent that is a source of a policy definition that governs said resource, said forwarding performed according to a referral policy comprising identification of said resource and identification of said second agent, wherein said policy definition for said resource is delegated by said first agent to said second agent by said referral policy and wherein said second agent provides a decision regarding said request.

11. The computer system of claim 10 wherein said request for access is evaluated by said second agent.

12. The computer system of claim 10 wherein said second agent retrieves said policy definition from a source of policy definitions coupled to said second agent.

13. The computer system of claim 12 wherein said second agent caches said policy definition in a memory cache accessible by said second agent.

14. The computer system of claim 10 wherein said decision comprises a decision value indicating whether access to said resource is granted.

15. The computer system of claim 14 wherein said decision further comprises decision values indicating actions that may be performed with said resource.

16. The computer system of claim 10 wherein said referral policy uses a Java interface.

17. The computer system of claim 10 wherein said first agent is associated with a first organizational entity and said second agent is associated with a second organizational entity, wherein said second organizational entity is subordinate to said first organizational entity in an organizational hierarchy.

18. The computer system of claim 10 wherein said first agent is associated with a first organizational entity and said second agent is associated with a second organizational entity, wherein said first and second organizational entities are peers in an organizational hierarchy.

19. A computer-usable medium having computer-readable program code embodied therein for causing a computer system to perform a method of controlling access to resources, said method comprising:
receiving at a first agent a request for access to a resource, wherein said first agent is authorized to delegate policy definitions that govern said resources to other agents; and
forwarding said request for access to a second agent that is a source of a policy definition that governs said resource, said forwarding performed according to a referral policy comprising identification of said resource and identification of said second agent, wherein said policy definition for said resource is delegated by said first agent to said second agent by said referral policy and wherein said second agent provides a decision regarding said request.

20. The computer-usable medium of claim 19 wherein said request for access is evaluated by said second agent.

21. The computer-usable medium of claim 19 wherein said second agent retrieves said policy definition from a source of policy definitions coupled to said second agent.

22. The computer-usable medium of claim 21 wherein said second agent caches said policy definition in a memory cache accessible by said second agent.

23. The computer-usable medium of claim 19 wherein said decision comprises a decision value indicating whether access to said resource is granted.

24. The computer-usable medium of claim 23 wherein said decision further comprises decision values indicating actions that may be performed with said resource.

25. The computer-usable medium of claim 19 wherein said referral policy uses a Java interface.

26. The computer-usable medium of claim 19 wherein said first agent is associated with a first organizational entity and said second agent is associated with a second organizational entity, wherein said second organizational entity is subordinate to said first organizational entity in an organizational hierarchy.

27. The computer-usable medium of claim 19 wherein said first agent is associated with a first organizational entity and said second agent is associated with a second organizational entity, wherein said first and second organizational entities are peers in an organizational hierarchy.
